(19) United States
(12) Patent Application Publication
(10) Pub. No.: US 2026/0219081 A1
(43) Pub. Date: Jul. 30, 2026

(54) ROTOR CRANKSHAFT DRIVEN POSITIVE DISPLACEMENT METER

(71) Applicant: Smith Meter Inc., Erie, PA (US)

(72) Inventors: Ronald J. Hahn, JR., Houston, TX (US); Jeffrey W. Lantz, Houston, TX (US); Karl J. Ostermann, Houston, TX (US); John T. Tingley, II, Houston, TX (US)

(73) Assignee: Smith Meter Inc., Erie, PA (US)

(21) Appl. No.: 19/039,490

(22) Filed: Jan. 28, 2025

(51) Int. Cl. G01F 1/07; G01F 15/14

(52) U.S. Cl. CPC G01F 1/07; G01F 15/14

(57) ABSTRACT

A positive displacement meter, systems including the positive displacement meter, and methods for measuring a volume of fluid. The meter includes a meter housing having a meter inner measurement chamber defining a flow bore through which a fluid is directed, a rotor assembly rotatably supported within the meter inner measurement chamber and configured to rotate as the fluid flows through the meter inner measurement chamber. The rotor assembly includes rotor blades and a crankshaft. Systems include a pipeline fluidly connected to an upstream process, a downstream process and a positive displacement meter configured to measure a volume of fluid flowing through the pipeline. Methods for measuring a volume of fluid include disposing a positive displacement meter on a pipeline, flowing the fluid through the pipeline, rotating the rotor assembly within the meter, and measuring the volume of the fluid as it flows through the positive displacement meter.

### BACKGROUND

Fluid meters are commonly used in a variety of industries, such as pharmaceuticals, food and beverage, oil and gas, and petrochemical industries. In the oil, gas, and petrochemical industries, fluid meters are used to measure large amounts of fluid passing through a pipeline in order to facilitate selling or otherwise transferring custody of the fluid, bulk transfer, or blending applications. One type of fluid meter commonly used for this purpose is a reciprocating blade positive displacement (PD) meter. One advantage of PD meters is that they provide accurate flow measurements regardless of fluid flow conditions entering the meter. PD meters measure direct fluid volume and are highly accurate and repeatable.

PD meters may be fabricated with an abundance of parts, leading to increased cost and complexity in the device. Increased complexity may lead to increased tolerance error and more failures than devices with simpler designs. Accordingly, there exists a need for a simplified PD meter with the ability to provide accurate flow measurements.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a positive displacement meter, including a meter housing having a meter inner measurement chamber defining a flow bore through which a fluid is directed, a fluid inlet located on an end of the flow bore, and a fluid outlet located on an opposite end of the flow bore from the fluid inlet, where the fluid flows from the fluid inlet, through the meter inner measurement chamber, and to the fluid outlet. The positive displacement meter also includes a rotor assembly rotatably supported within the meter inner measurement chamber, where the rotor assembly is configured to rotate as the fluid flows through the meter inner measurement chamber. The rotor assembly includes a plurality of rotor blades, each of which includes two interconnected, diametrically opposite blades, and a crankshaft disposed within a central opening of each of the plurality of rotor blades, where the crankshaft is constructed as a single body or as an assembly of parts. The positive displacement meter also includes a first meter cover and a second meter cover, where the first meter cover and the second meter cover are bolted to opposites sides of the meter housing to cover the meter inner measurement chamber, thereby containing the fluid in the meter inner measurement chamber.

In another aspect, embodiments disclosed herein relate to a system including a pipeline fluidly connected to an upstream process and a downstream process, and at least one positive displacement meter disposed on the pipeline. In the system, each of the at least one positive displacement meters includes a meter housing having a meter inner measurement chamber defining a flow bore through which a fluid is directed, a fluid inlet located on an end of the flow bore, and a fluid outlet located on an opposite end of the flow bore from the fluid inlet, where the fluid flows from the fluid inlet, through the meter inner measurement chamber, and to the fluid outlet. The positive displacement meter also includes a rotor assembly rotatably supported within the meter inner measurement chamber, where the rotor assembly is configured to rotate as the fluid flows through the meter inner measurement chamber. The rotor assembly includes a plurality of rotor blades, each of which includes two interconnected, diametrically opposite blades, and a crankshaft disposed within a central opening of each of the plurality of rotor blades, where the crankshaft is constructed as a single body or as an assembly of parts. The positive displacement meter also includes a first meter cover and a second meter cover, where the first meter cover and the second meter cover are bolted to opposites sides of the meter housing to cover the meter inner measurement chamber, thereby containing the fluid in the meter inner measurement chamber. In the system, the at least one positive displacement meter is configured to measure a volume of fluid flowing through the pipeline from the downstream process to the upstream process.

In yet another aspect, embodiments disclosed herein relate to a method for measuring a volume of fluid, including disposing at least one positive displacement meter on a pipeline, where each of the at least one positive displacement meter includes a meter housing having a meter inner measurement chamber defining a flow bore through which a fluid is directed, a fluid inlet located on an end of the flow bore, and a fluid outlet located on an opposite end of the flow bore from the fluid inlet, where the fluid flows from the fluid inlet, through the meter inner measurement chamber, and to the fluid outlet. The positive displacement meter also includes a rotor assembly rotatably supported within the meter inner measurement chamber, where the rotor assembly is configured to rotate as the fluid flows through the meter inner measurement chamber. The rotor assembly includes a plurality of rotor blades, each of which includes two interconnected, diametrically opposite blades, and a crankshaft disposed within a central opening of each of the plurality of rotor blades, where the crankshaft is constructed as a single body or as an assembly of parts. The positive displacement meter also includes a first meter cover and a second meter cover, where the first meter cover and the second meter cover are bolted to opposites sides of the meter housing to cover the meter inner measurement chamber, thereby containing the fluid in the meter inner measurement chamber. The method also includes flowing the fluid through the pipeline, through the fluid inlet of the at least one positive displacement meter, rotating the rotor assembly within the meter inner measurement chamber, as the fluid flows through the meter inner measurement chamber, flowing the fluid to the fluid outlet of the at least one positive displacement meter, and measuring the volume of the fluid as it flows through the at least one positive displacement meter.

Other aspects and advantages of the claimed subject matter will be apparent from the following description and the appended claims.

### BRIEF DESCRIPTION OF DRAWINGS

FIG. 1A shows a first side view of a positive displacement meter according to one or more embodiments.

FIG. 1B shows a second side view of a positive displacement meter according to one or more embodiments.

FIG. 2A shows a first side exploded view of a positive displacement meter according to one or more embodiments.

FIG. 2B shows a second side exploded view of a positive displacement meter according to one or more embodiments.

FIG. 3 shows a front view (with covers removed) of a meter housing according to one or more embodiments.

FIG. 4 shows a cutaway view and flow path within a meter housing according to one or more embodiments.

FIG. 5 shows an exploded view of a rotor assembly within a positive displacement meter according to one or more embodiments.

FIG. 6A shows a rotor assembly according to one or more embodiments.

FIG. 6B shows a cutaway view of a rotor assembly according to one or more embodiments.

FIG. 6C shows a rotor blade according to one or more embodiments.

FIG. 6D shows a crankshaft according to one or more embodiments.

FIG. 6E shows a configuration of rotor blades and a crankshaft according to one or more embodiments.

FIG. 7A a crankshaft assembly exploded view according to one or more embodiments.

FIG. 7B shows a crankshaft assembly second side exploded view according to one or more embodiments.

FIG. 7C shows a crankshaft assembly cutaway side view according to one or more embodiments.

FIG. 8A shows a meter cutaway view according to one or more embodiments.

FIG. 8B shows a meter cutaway side view according to one or more embodiments.

FIG. 8C shows a second meter cutaway side view according to one or more embodiments.

FIG. 9A shows a sensor housing face location of a sensor assembly according to one or more embodiments.

FIG. 9B shows the components of a sensor assembly according to one or more embodiments.

FIG. 9C shows a sensor path according to one or more embodiments.

FIG. 9D shows a zoomed in portion of a sensor assembly according to one or more embodiments.

FIG. 10 shows a system according to one or more embodiments.

### DETAILED DESCRIPTION

Throughout the application, ordinal numbers (for example, first, second, third) may be used as an adjective for an element (that is, any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a fluid sample” includes reference to one or more of such samples.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Although multiply dependent claims are not introduced, it would be apparent to one of ordinary skill that the subject matter of the dependent claims of one or more embodiments may be combined with other dependent claims.

Embodiments disclosed herein generally relate to an improved positive displacement meter. The positive displacement meter of one or more embodiments may include a meter housing, a rotor assembly, and one or more meter covers. The positive displacement meter of one or more embodiments may advantageously be constructed of fewer parts compared to the prior art. Specifically, as will be described further in later sections, the positive displacement meter disclosed herein may include a crankshaft design, versus a cam shaft design as in the prior art. The crankshaft design according to one or more embodiments may advantageously provide a lower cost, may lower acceleration forces upon rotation, and may increase flow rates within the positive displacement meter disclosed herein. Furthermore, one or more components of the positive displacement meter of one or more embodiments may advantageously provide capillary seals during fluid measurement, leading to a more accurate fluid measurements.

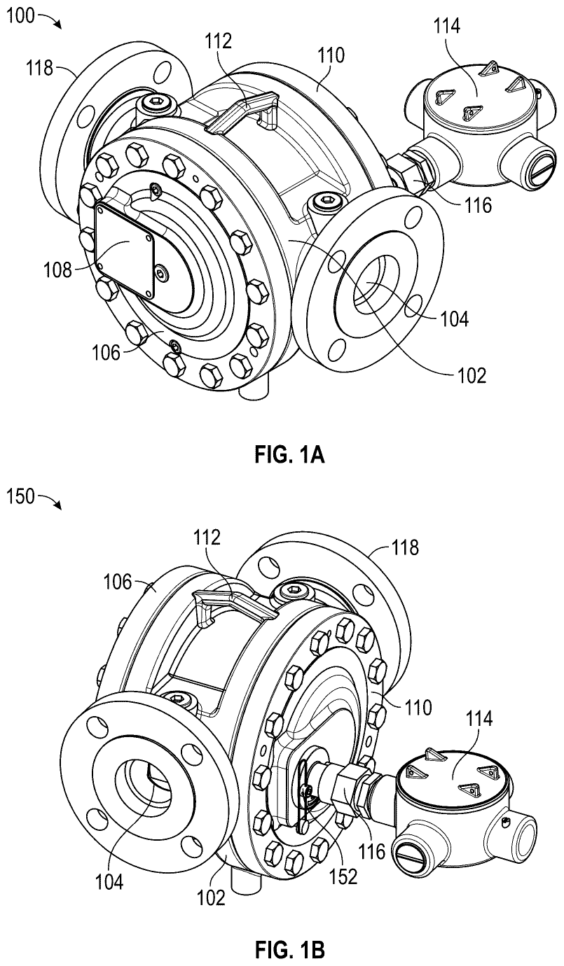

FIG. 1A shows a first side view of a positive displacement meter 100 according to one or more embodiments. The positive displacement meter 100 of one or more embodiments includes a meter housing 102, a first meter cover 106, and a second meter cover 110. The first meter cover 106 may include a surface boss 108 for recording a serial number or other identification purposes. The meter housing 102 includes a meter inner measurement chamber (e.g., 208, not shown in FIG. 1A) defining a flow bore through which a fluid may be directed. A fluid inlet 118 may be located on a first end of the flow bore and a fluid outlet 104 may be located on an opposite end of the flow bore from the fluid inlet 118, where the fluid flows from the fluid inlet 118, through the meter inner measurement chamber 208, and to the fluid outlet 104. The openings to the flow bore (i.e., fluid inlet 118 and fluid outlet 104) through the meter housing are referred to herein as “inlet” and “outlet” merely for distinction between the different openings. This designation is not meant to be limiting, and, depending on the direction of fluid flow, the openings may act as either an inlet or an outlet. As shown in FIG. 1A, the first meter cover 106 and the second meter cover 110 may be bolted to opposites sides of the meter housing 102 to cover the meter inner measurement chamber 208, thereby containing a fluid therein. A lifting lug 112 may be formed on a top surface of the meter housing 102, allowing for ease of lifting/moving the positive displacement meter 100.

Although the Figures describe a positive displacement meter 100 having a first meter cover 106 and a second meter cover 110, the positive displacement meter 100 may have a single meter cover without departing from the present disclosure. For example, in some embodiments, the positive displacement meter 100 may be constructed of a meter housing which is enclosed on a first side and includes a removable meter cover on a second side.

AAs best shown in FIG. 1B, a sensor assembly 152 may be connected on one side to a junction box 114 via a union 116, where the junction box 114 may be configured to provide power and signal connections to the sensor assembly 152. In accordance with one or more embodiments, the junction box 114 has field connections for power and signal to the sensor assembly 152. On a side opposite to the junction box 114 connection, the sensor assembly 152 may be connected to the second meter cover 110. The sensor assembly will be described in more detail, below.

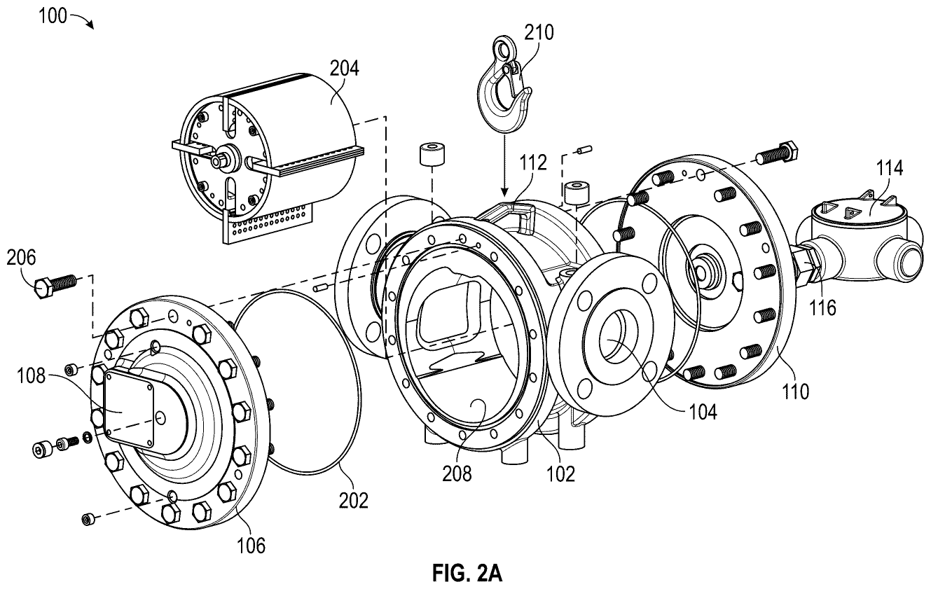

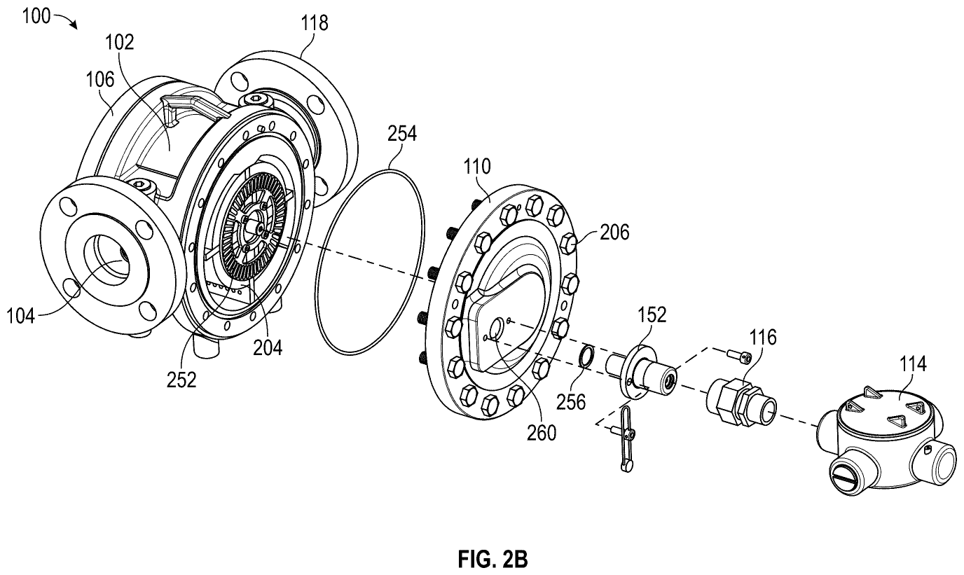

FIG. 2A shows a first side exploded view of a positive displacement meter 100 according to one or more embodiments. As described above, the positive displacement meter 100 includes a meter housing 102 having a meter inner measurement chamber 208 machined within the interior of the meter housing 102. The positive displacement meter 100 may be moved by a lifting lug 112, formed in the meter housing 102, using a clip 210 that can clip into the lifting lug 112. The meter inner measurement chamber 208 defines a flow bore through which a fluid may be directed. The first meter cover 106 and the second meter cover 110 may be bolted via one or more bolts 206 to opposites sides of the meter housing 102 to cover the meter inner measurement chamber 208 and contain a fluid therein. A first meter cover o-ring 202 may be disposed between the first meter cover 106 and the meter housing 102 to further provide a fluid seal. A rotor assembly 204 may be rotatably supported within the meter inner measurement chamber 208. In one or more embodiments, the rotor assembly 204 is configured to rotate as the fluid flows through the meter inner measurement chamber 208. The rotor assembly 204 will be described in more detail, below.

FIG. 2B shows a second side exploded view of a positive displacement meter 100 according to one or more embodiments. The second meter cover 110 may be bolted via one or more bolts 206 and a second meter cover o-ring 254 may be disposed between the second meter cover 110 and the meter housing 102 to further provide a fluid seal. FIG. 2B shows a second side of the rotor assembly 204, including a reluctor ring 252 affixed to the second side of the rotor assembly 204. The second meter cover 110 includes a second cover outer hole 260 configured to receive the sensor assembly 152. A sensor o-ring 256 may be disposed within the second cover outer hole 260 to further provide a fluid seal.

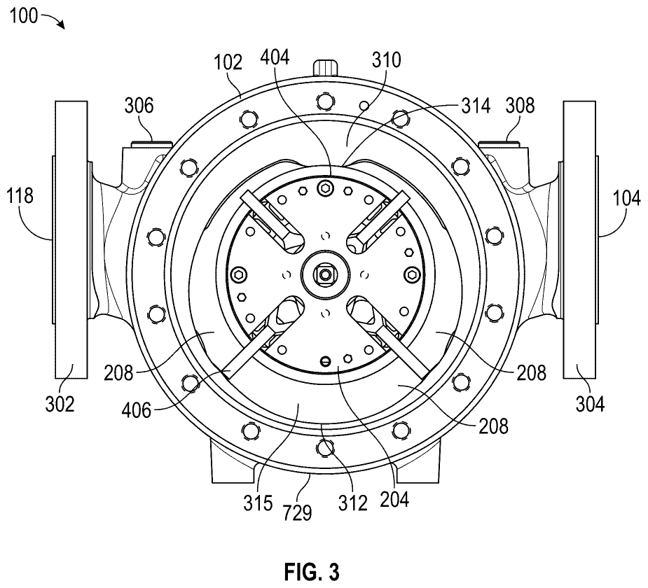

FIG. 3 shows a front view (with covers removed) of a meter housing according to one or more embodiments. As described above, a meter inner measurement chamber 208 may be formed in a meter housing 102 of a positive displacement meter 100. A first flange 302 may be disposed on a first side of the meter housing 102, where the first flange 302 includes a fluid inlet 118. Similarly, a second flange 304 may be formed on an opposite side of the meter housing 102 from the first flange 302. The second flange 304 may include a fluid outlet 104. The positive displacement meter 100 may also include one or more sensor ports. For example, a first sensor port 306 and a second sensor port 308 may be formed on an axially upper surface of the meter housing 102.

The size of the first flange 302 and the second flange 304 may have any size known in the art. As a non-limiting example, the first flange 302 and the second flange 304 may have an inner diameter in a range of from about 2 inches to about 6 inches.

A sensor port is defined herein as a mounting location for a measuring instrument (e.g., a thermometer, a temperature sensor, a pressure sensor, or the like) and one or more fluids. A sensor port is provided for allowing accurate temperature and pressure readings of the fluid flowing through the positive displacement meter 100 for temperature and pressure compensation and/or weights and measures verification.

Keeping with FIG. 3, the meter inner measurement chamber 208 may have a block element 310 machined therein. Additionally, a rotor assembly 204 is shown rotatably supported within the meter inner measurement chamber 208. The block element 310 of one or more embodiments may help to direct the travel of fluid flow in a desired direction in order to push the rotor assembly 204 towards a measuring portion of the positive displacement meter 100.

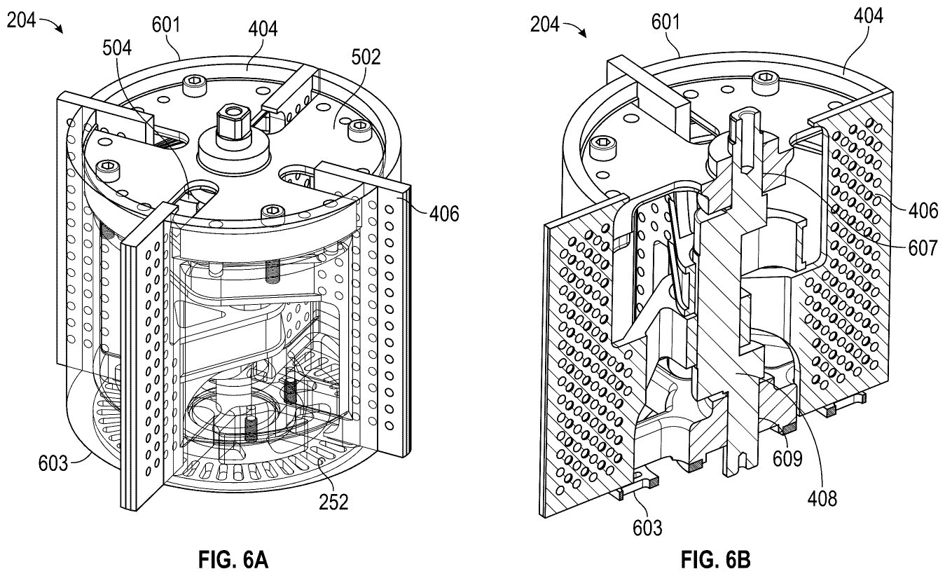

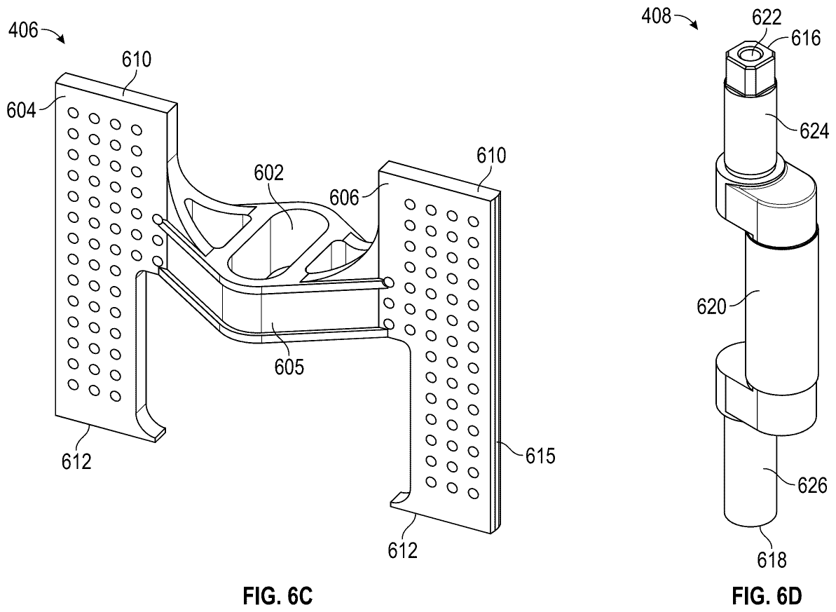

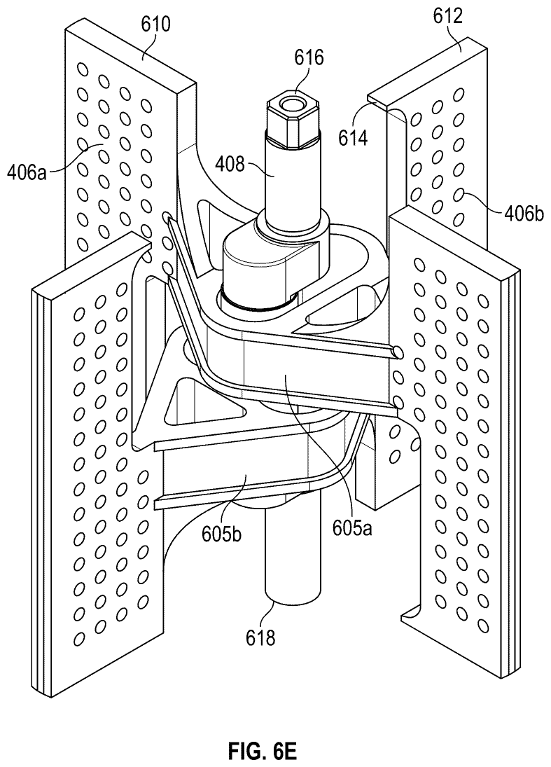

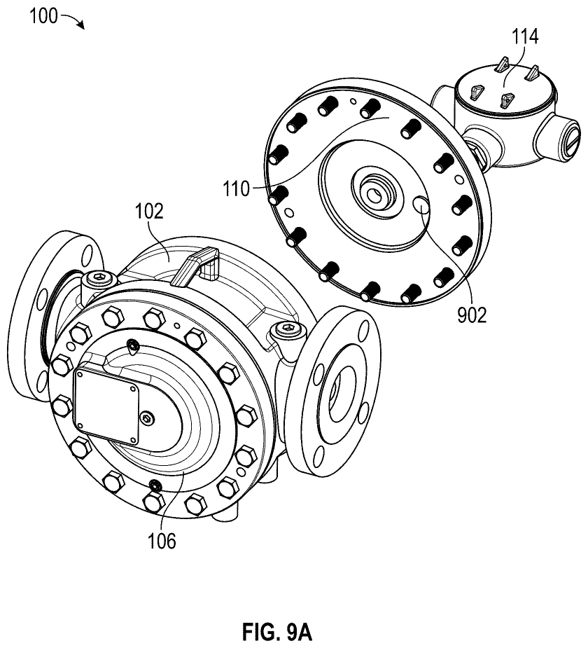

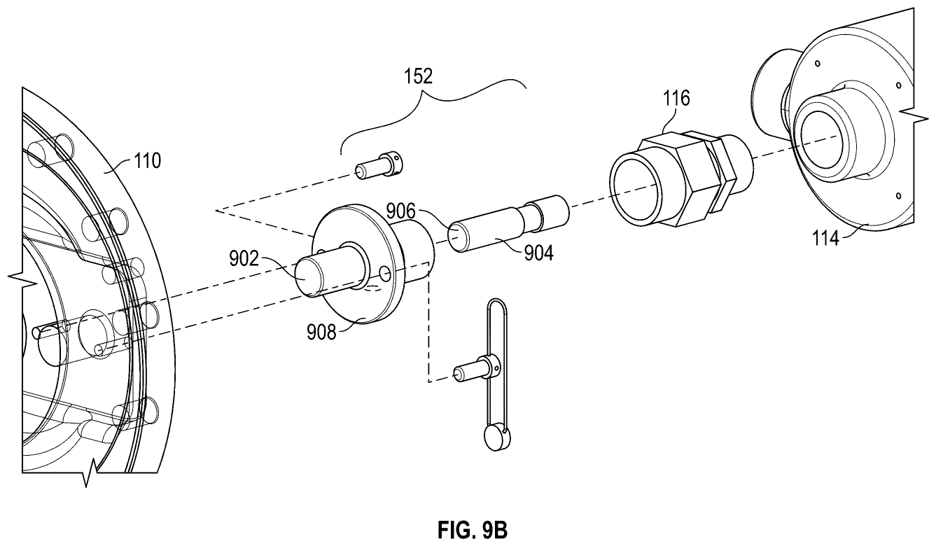

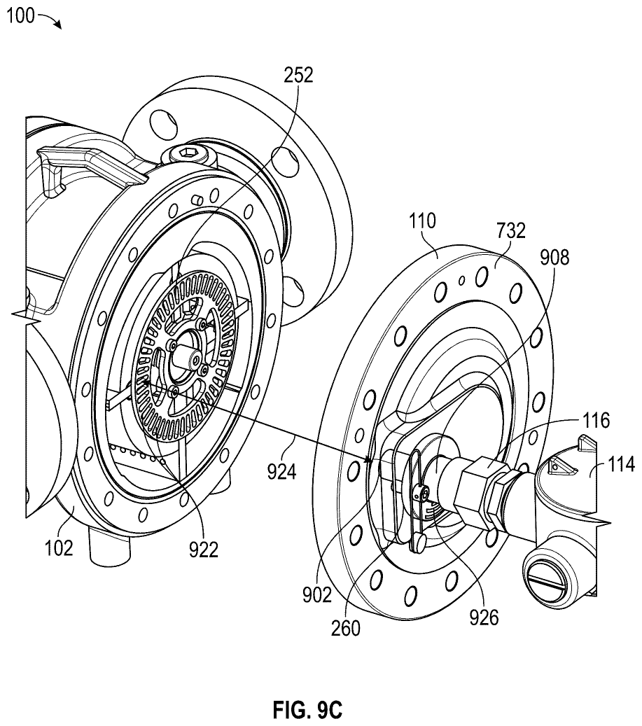

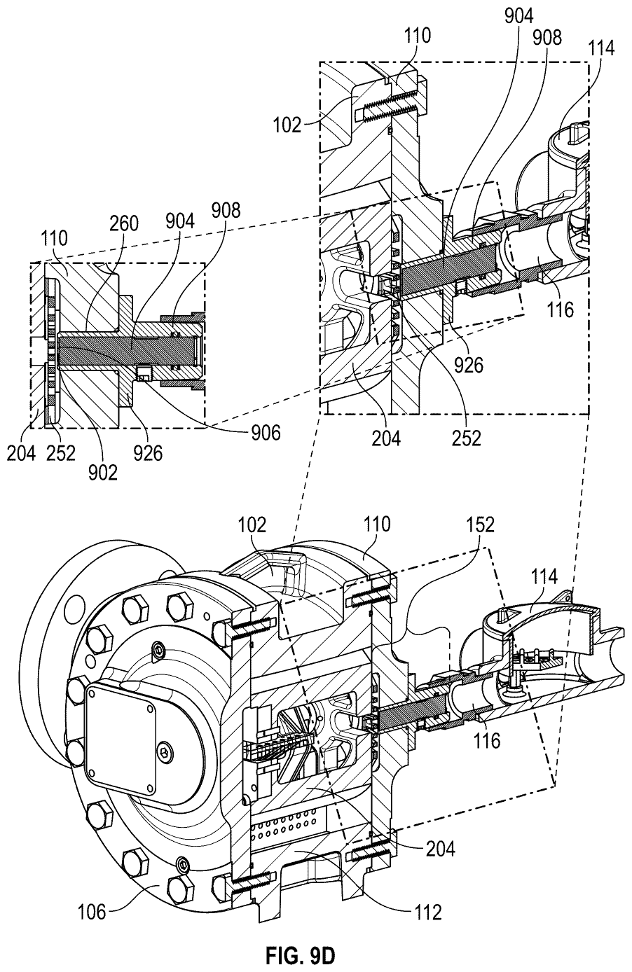

In general, measuring a volume of fluid flowing through the positive displacement meter 100 of one or more embodiments may be accomplished as follows. As a fluid enters the meter inner measurement chamber 208, the flowing fluid pushes a plurality of rotor blades 406 as part of the rotor assembly 204, causing the rotor assembly 204 to rotate within the meter inner measurement chamber 208. When two of the rotor blades 406 are positioned at four o'clock and eight o'clock positions (such as the two rotor blades 406 proximate the meter bottom 729 shown in FIG. 3), a precisely known volume of fluid is segmented in a measurement section 315 of the meter inner measurement chamber 208. The measurement section 315 is a machined in section within the meter inner measurement chamber 208 of housing 102, defined by a non-circular surface of a section of the meter inner wall 312. Specifically, the volume of fluid which is captured between the two rotor blades 406 positioned at four o'clock and 8 o'clock positions and the outside diameter of rotor body 404, within measurement section 315 is a precise volume of fluid within the meter inner measurement chamber 208. A counting mechanism counts and records each volume of flowing fluid which enters and exits the meter inner measurement chamber 208. Specifically, according to embodiments disclosed herein, slots formed within a reluctor ring 252 positioned on rotor second side 603 (e.g., as shown in FIGS. 6A-B) of the rotor assembly 204, rotate as the rotor assembly 204 rotates and a number of reluctor ring slots (e.g., 922 in FIG. 9C) are detected by the sensor assembly 152. Finally, the number of reluctor ring slots (e.g., 922 in FIG. 9C) detected by the sensor assembly 152 may be correlated to a corresponding volume of fluid flowing through the meter inner measurement chamber 208.

As the rotor assembly 204 rotates within the meter inner measurement chamber 208, the two rotor blades 406 proximate the block element 310 are fully retracted into the rotor body such that they do not contact the block element 310 upon rotation past the block element 310. Furthermore, during rotation of the rotor assembly 204 within the meter inner measurement chamber 208, a block outer surface 314 of the block element 310 comes in close proximity to the outer surface of the rotor body 404, thereby providing a capillary seal against fluid flowing within the meter inner measurement chamber 208. The capillary seal is continuously maintained during rotation of the rotor assembly 204 because the width of plurality of slots (e.g., 504 in FIG. 6A) configured to receive the plurality of rotor blades 406 is less than an arc length of the block outer surface 314. Creation of a capillary seal may advantageously help prevent fluid loss thereby ensuring a more accurate meter reading.

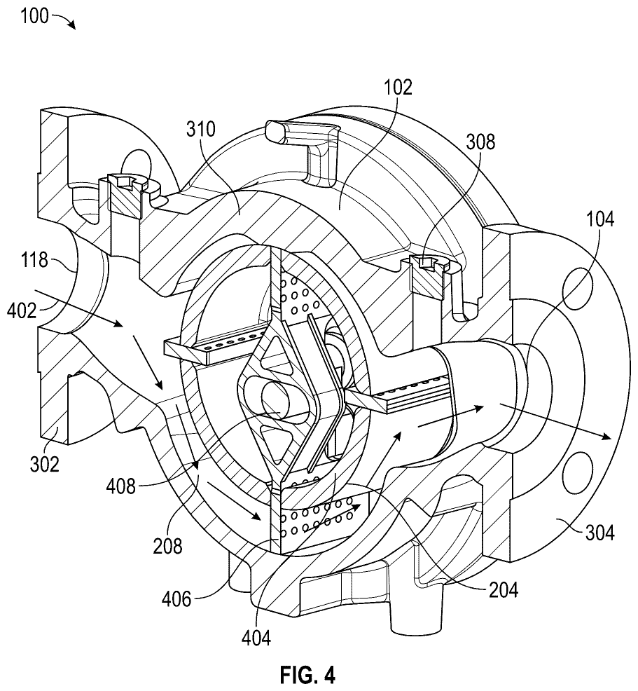

FIG. 4 shows a cutaway view and flow path 402 within a meter housing 102 according to one or more embodiments. A fluid may be directed to a fluid inlet 118 connected to a bore formed within the meter inner measurement chamber 208. As will be described in more detail below, the rotor assembly 204 includes a rotor body 404 having a plurality of rotor blades 406 slidably positioned within the rotor body 404. As the fluid flows along the flow path 402, the fluid may contact one or more rotor blades 406 as part of the rotor assembly 204. A crankshaft 408 may be centrally disposed within the plurality of rotor blades 406, where the crankshaft 408 is configured to generally remain stationary when the flowing fluid contacts the plurality of rotor blades 406. The fluid may then proceed to flow past the rotor assembly 204 and to fluid outlet 104.

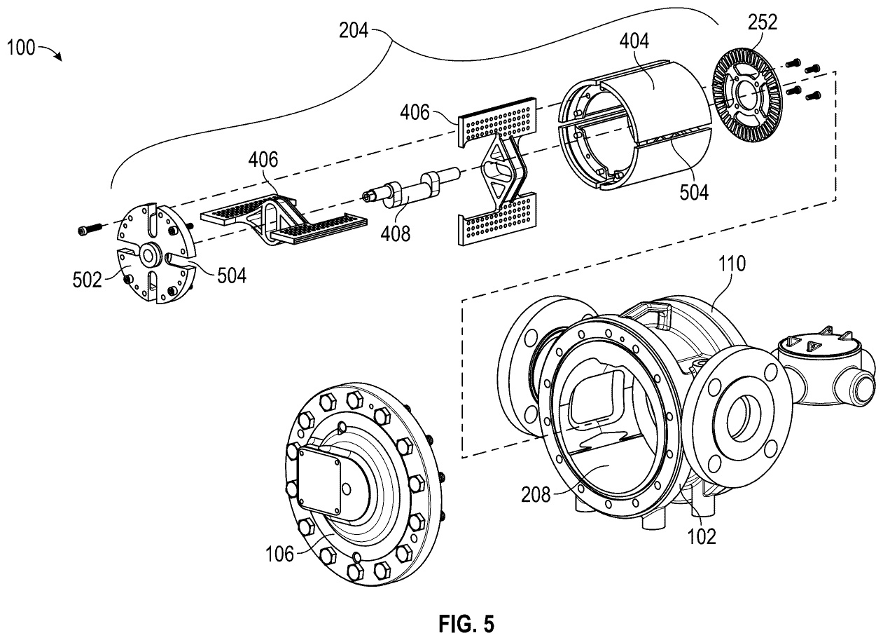

FIG. 5 shows an exploded view of a rotor assembly 204 within a positive displacement meter 100 according to one or more embodiments. The rotor assembly 204 of one or more embodiments may include a rotor body 404 having a rotor cover 502 on a rotor first side (e.g., 601 in FIGS. 6A-B) and a reluctor ring 252 on an axially opposite side (e.g., rotor second side 603 in FIGS. 6A-B). The rotor body 404 and the rotor cover 502 may include a plurality of slots 504 configured to receive a plurality of rotor blades 406. Additionally, the plurality of rotor blades 406 and a crankshaft 408 may be disposed within the rotor body 404.

Turning to FIGS. 6A-B, a rotor assembly 204 and a cutaway view of a rotor assembly 204, respectively, are illustrated according to one or more embodiments. As shown in FIG. 6A, the rotor body 404, including the plurality of slots 504, may radially surround the rotor assembly 204. As described above, the rotor body 404 may further include a rotor first side 601 and a rotor second side 603, where the rotor first side 601 is located axially opposite the rotor second side 603. A rotor cover 502 may also include a plurality of slots 504. The rotor cover 502 may be affixed to the rotor first side 601 of the rotor body 404. In addition, a reluctor ring 252 may be affixed to the rotor second side 603 of the rotor body 404. As shown in FIG. 6A, the plurality of slots 504 formed in the rotor body 404 and the rotor cover 502 are configured to fit the plurality of rotor blades 406. As best shown in FIG. 6B, a crankshaft 408 may be disposed within the rotor body 404, centrally between the plurality of rotor blades 406.

The crankshaft 408 of one or more embodiments may be affixed to the first meter cover 106 and the second meter cover 110, as will be described in more detail, below. Accordingly, when the rotor assembly 204 is positioned around the stationary crankshaft 408 within the positive displacement meter 100, the rotor assembly 204 rotates around the crankshaft 408. For example, when a fluid flows within the positive displacement meter 100 and pushes the rotor blades 406, the components of the rotor assembly 204, including the rotor blades 406 and rotor body 404 having a rotor cover 502 affixed to the rotor first side 601 and a reluctor ring 252 affixed to the rotor second side 603, may all rotate around the crankshaft 408.

FIG. 6C shows a rotor blade 406 according to one or more embodiments. The rotor blade 406 includes a yoke 605, interconnecting a first blade 604 on a first side of the yoke 605 and a second blade 606 on a diametrically opposite side of the yoke 605. A central opening 602 may be located within the yoke 605. Each of the first blade 604 and the second blade 606 include a blade first end surface 610 on a first side and a blade second end surface 612 on an axially opposite side. The first blade 604 and the second blade 606 also include a blade outer surface 615 located on a side of the rotor blade 406 perpendicular to the blade first end surface 610 and the blade second end surface 612. The blade outer surface 615 may be positioned to interface with one or more portions of the meter chamber inner wall (312 in FIG. 3). Specifically, when the blade outer surface 615 comes in close proximity to the meter chamber inner wall 312, a capillary seal is provided between the two elements. Creation of a capillary seal between the blade outer surface 615 and the meter chamber inner wall 312 may advantageously allow for a more precise volume of fluid to be measured when two of the rotor blades 406 are positioned at four o'clock and 8 o'clock positions (such as the two rotor blades 406 proximate the meter bottom 729 shown in FIG. 3) and a known volume of fluid is segmented in a measurement section 315 of the meter inner measurement chamber 208, as described above.

The plurality of rotor blades 406 according to one or more embodiments may be constructed using a suitable method and material known in the art. In some embodiments, the rotor blades 406 are constructed from injection molded plastics, cast metal, or an assembly of parts.

Turning to FIG. 6D, FIG. 6D shows a crankshaft 408 according to one or more embodiments. The crankshaft 408 includes a crankshaft elongated portion 620 interconnecting a crankshaft first protrusion 624 and a crankshaft second protrusion 626, the crankshaft second protrusion 626 being located on an axially opposite end from the crankshaft first protrusion 624. The crankshaft first protrusion 624 terminates at a crankshaft first end surface 616 and the crankshaft second protrusion 626 terminates at a crankshaft second end surface 618. In one or more embodiments, the crankshaft first end surface 616 includes a crankshaft first end hole 622.

The crankshaft 408 disclosed herein may be used to translate rotational motion of the rotor assembly 204 into linear motion of the rotor blades 406. Specifically, central openings 602 formed in the rotor blades 406 rotate around the crankshaft elongated portion 620 as the rotor assembly 204 rotates. Linear travel of the rotor blades 406 (also known as “throw”) occurs in response to the central openings 602 sliding around the crankshaft elongated portion 620 and defines a path of travel within the positive displacement meter 100. The path of travel effectively segments the fluid every one quarter rotation of the rotor assembly 204, allowing for accurate fluid volume measurement. In one or more embodiments, a precisely known volume of fluid is segmented in the measurement section 315 of the meter inner measurement chamber (e.g., 208 in FIG. 3), the outside diameter of rotor body 404 and the rotor blades 406 are fully extended at four o'clock and 8 o'clock positions (e.g., the positions shown in FIG. 3) and the blade outer surface 615 comes in close proximity to the meter chamber inner wall 312 to form a capillary seal.

In one or more embodiments, the crankshaft 408 may advantageously be constructed/manufactured as a single body. For example, a single body crankshaft 408 may be produced by any technique known in the art including casting, forging, bar stock, and the like. In some embodiments, the crankshaft 408 may be constructed from a combination of parts to form a crankshaft 408 assembly.

The crankshaft 408 according to one or more embodiments may be constructed using a suitable method and material known in the art. As a non-limiting example, the crankshaft 408 may be constructed from hardened tool steels, hard plated or coated steels, case hardened steels, precipitation hardening stainless steels, and the like.

FIG. 6E shows a configuration of rotor blades and a crankshaft 408 according to one or more embodiments. In FIG. 6E, a first rotor blade 406a and a second rotor blade 406b are positioned with the blade first end surface 610 of the first rotor blade 406a pointing in the same axial direction as the blade second end surface 612 of the second rotor blade 406b. The first rotor blade 406a includes a first rotor blade yoke 605a and the second rotor blade 406b includes a second rotor blade yoke 605b. Each of the first rotor blade yoke 605a and the second rotor blade yoke 605b include a central opening (e.g., 602). In one or more embodiments, the first rotor blade 406a may be stacked upon the second rotor blade 406b such that the central opening (e.g., 602) formed in the first rotor blade yoke 605a and the central opening (e.g., 602) formed in the second rotor blade yoke 605b are axially aligned. A crankshaft 408 may be positioned within the aligned central openings of a first rotor blade yoke 605a and the second rotor blade yoke 605b.

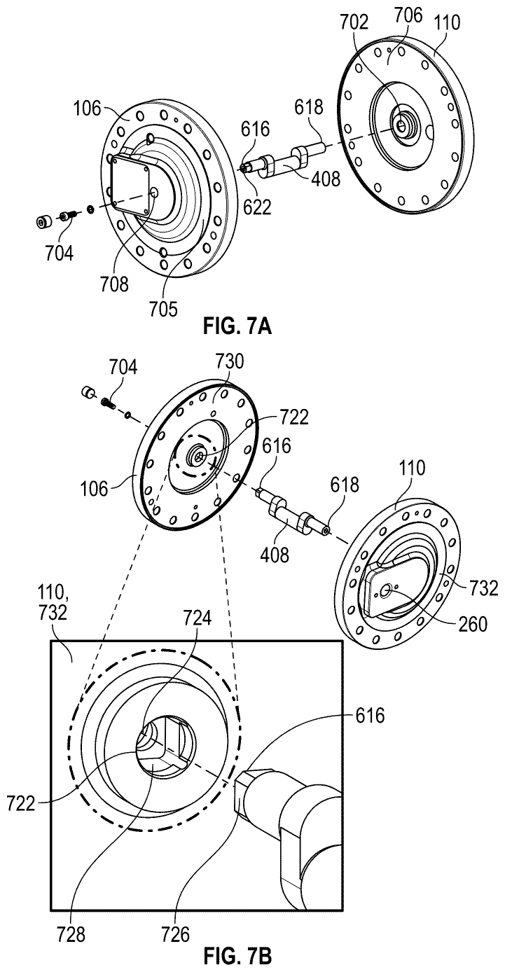

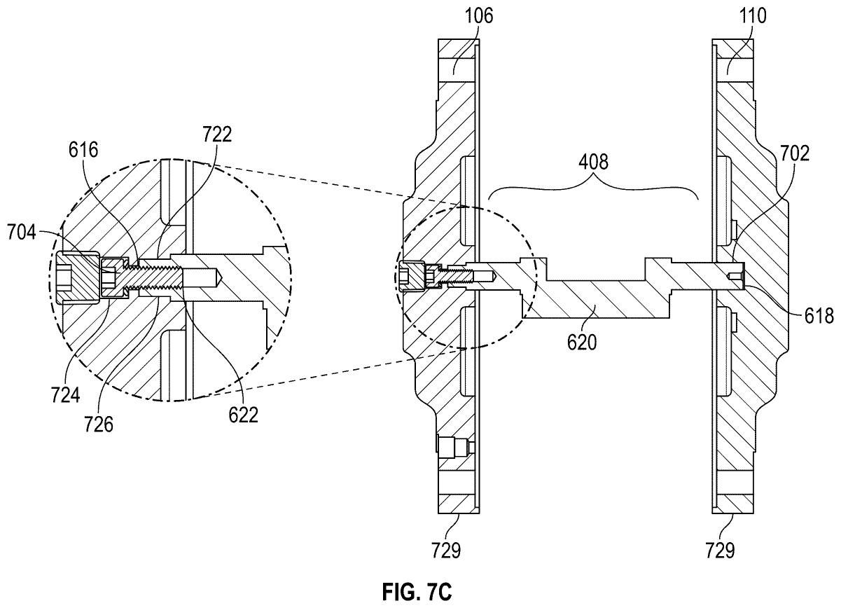

FIG. 7A shows a crankshaft 408 assembly exploded view according to one or more embodiments. As described above, the crankshaft 408 includes a crankshaft first end surface 616, having a crankshaft first end hole 622, and a crankshaft second end surface 618 on an axially opposite end of the crankshaft 408 to the crankshaft first end surface 616. Additionally, the first meter cover 106 includes a first cover outer surface 705 having a first cover outer hole 708. The second meter cover 110 includes a second cover inner surface 706 having a second cover inner hole 702, where the second cover inner surface 706 axially aligns with and faces the meter inner measurement chamber 208.

FIG. 7B shows a crankshaft 408 assembly second side exploded view according to one or more embodiments. The first meter cover 106 includes a first cover inner surface 730 having a first cover inner hole 722, where the first cover inner surface 730 axially aligns with and faces the meter inner measurement chamber 208. The first cover inner surface 730 is located axially opposite to the first cover outer surface 705. In one or more embodiments, the crankshaft first end surface 616 is configured to interface with the first cover inner hole 722. Similarly, the second meter cover 110 includes a second cover outer surface 732 having a second cover outer hole 260. The second cover outer surface 732 is located axially opposite to the second cover inner surface 706.

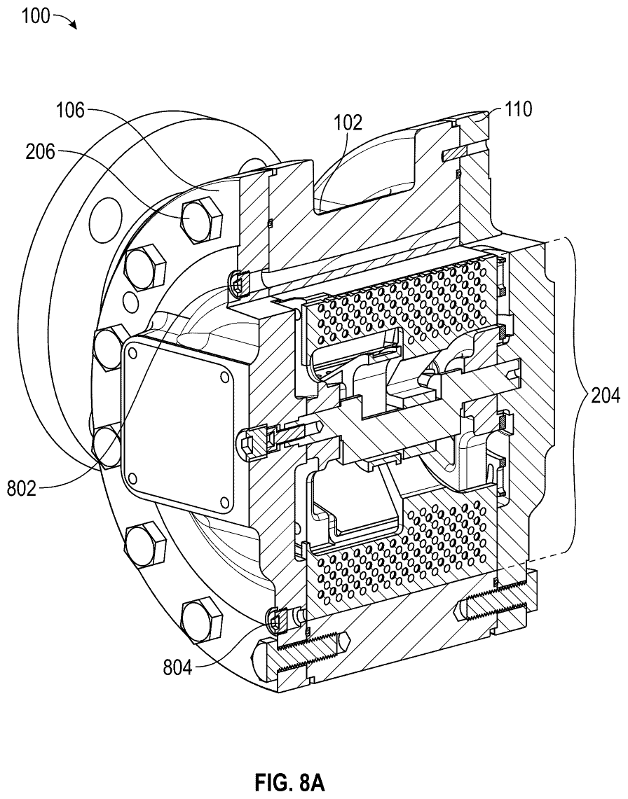

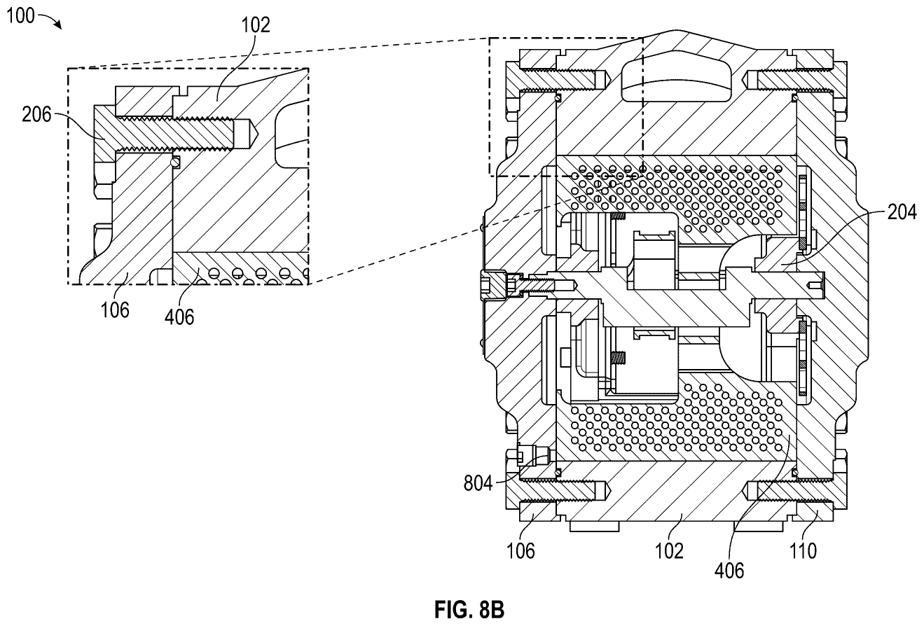

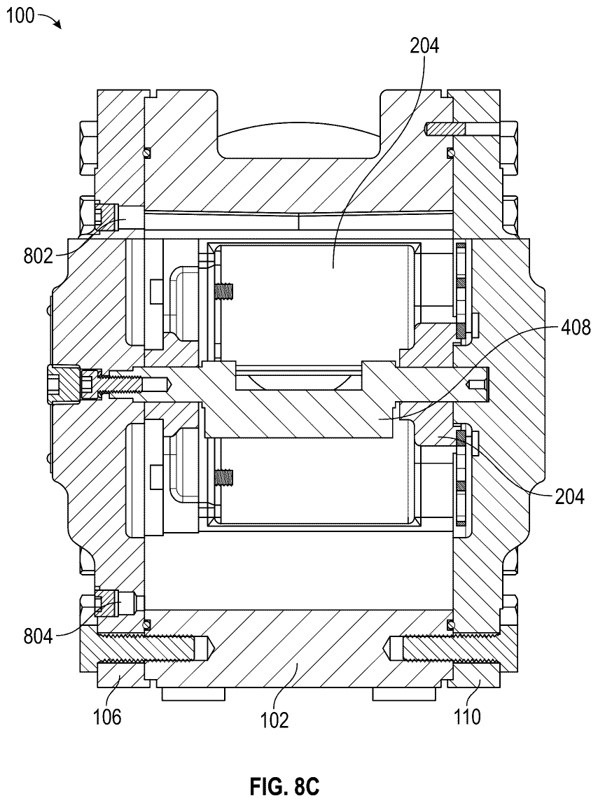

In one or more embodiments, the rotor assembly 204 is affixed to the positive displacement meter 100 by disposing the crankshaft second end surface 618 in the second cover inner hole 702, as best shown in FIG. 7A. As shown in the zoomed in portion of FIG. 7B, the first cover inner hole 722 located within the first cover inner surface 730 may have a square shaped profile 728. A first cover bolt hole 724 located within the first cover inner hole 722 may have a smaller diameter than the first cover inner hole 722. A crankshaft first end nub 726 located proximate the crankshaft first end surface 616 may have a corresponding square shaped profile configured to fit within the first cover inner hole 722. The square shaped profile may advantageously prevent rotation of the crankshaft first end nub 726 radially within the first cover inner hole 722. A crankshaft bolt 704 may be inserted through the first cover outer hole 708, the first cover inner hole 722 (e.g., through the first cover bolt hole 724), and into a crankshaft first end hole 622 (as best shown in FIG. 7A). The first cover inner hole 722 and the second cover inner hole 702 each accept a diameter of the crankshaft first end surface 616 and the crankshaft second end surface 618, respectively, in order to axially align the crankshaft 408 with the first meter cover 106 and the second meter cover 110. Furthermore, the first meter cover 106 and the second meter cover 110 are axially aligned with the meter housing 102 via a close tolerance fit of the rabbet joint (e.g., bolt 206 shown in the zoomed in portion of FIG. 8B). In one or more embodiments, a rotor first side hole 607 in the rotor first side 601 and a rotor second side hole 609 in the rotor second side 603 each accept a diameter of the crankshaft first protrusion 624 and the crankshaft second protrusion 626, respectively (see also, FIG. 6B). The rotor first side hole 607 and the rotor second side hole 609 act as journal bearings that rotate on the crankshaft first protrusion 624 and the crankshaft second protrusion 626 diameters, thereby axially aligning the rotor assembly 204 (See also, FIG. 6D).

FIG. 7C shows a crankshaft 408 assembly cutaway side view according to one or more embodiments. In FIG. 7C, the crankshaft 408 portion of the rotor assembly 204 is shown connected to the first meter cover 106 and the second meter cover 110 of positive displacement meter 100. Specifically, as described above, the crankshaft second end surface 618 of the crankshaft 408 is inserted into the second cover inner hole 702 in the second meter cover 110 and the first end nub 726 is inserted into the first cover inner hole 722 of the first meter cover 106. A crankshaft bolt 704 is shown inserted into the first cover outer hole 708, the first cover inner hole 722 (e.g., through the first cover bolt hole 724), and into a crankshaft first end hole 622. When assembled, the crankshaft elongated 620 portion is positioned proximate a meter bottom 729 of the positive displacement meter 100.

FIG. 8A shows a positive displacement meter 100 cutaway view according to one or more embodiments. In addition to the components of the positive displacement meter 100 described above, the positive displacement meter 100 may further include one or more vent ports 802 and one or more drain ports 804, both extending from the first cover outer surface 705 through the first meter cover 106 and into the meter inner measurement chamber 208. The vent ports 802 of one or more embodiments are defined herein as openings designed to allow a gas to escape from the meter housing 102. The vent ports 802 may be used to bleed entrapped air from the positive displacement meter 100 when first filled with fluid. Upon removing entrapped air from the system, the vent ports 802 are plugged to prevent air from entering the meter inner measurement chamber 208. Similarly, the drain ports 804 of one or more embodiments are defined herein as an opening designed to allow a liquid to escape from the meter housing 102. The drain ports 804 may advantageously allow for removal of liquid within the meter inner measurement chamber 208 for maintenance or cleaning purposes. The vent ports 802 may also allow air to enter the positive displacement meter 100 when drain ports 804 are opened in order to facilitate the flow of fluid out of the meter.

FIG. 8B shows a positive displacement meter 100 second cutaway side view according to one or more embodiments. In FIG. 8B, a side view of the plurality of rotor blades 406 as part of the rotor assembly 204 are shown. The rotor assembly 204 is not fixed axially on the crankshaft 408, but rather the rotor assembly 204 is designed with clearance about the crankshaft 408 so that the rotor assembly 204 can slide axially on the crankshaft bearing journal areas (e.g., small diameters at each end of the crankshaft, not shown). A “journal bearing” is defined herein as a smooth, cylindrical surface on the crankshaft (e.g., the “journal”). The ability for the rotor assembly 204 to slide on crankshaft bearing journal areas forms a capillary seal on each end of the rotor body 204 so that when fluid passes through the positive displacement meter 100 the fluid cannot bypass over and under the rotor assembly 204. Not having the rotor assembly 204 affixed axially on the crankshaft 408 may advantageously help eliminate a mechanical method to position the rotor assembly 204 which would in turn add extra complexity, cost, and machining tolerances.

FIG. 8C shows a positive displacement meter 100 cutaway side view according to one or more embodiments. In FIG. 8C, a vent port 802 and a drain port 804 are shown on the first meter cover 106. The rotor assembly 204 is shown such that the plurality of rotor blades 406 are not visible.

FIG. 9A shows a location of a sensor housing face 902 as part of the sensor assembly 152 within the positive displacement meter 100 according to one or more embodiments. In one or more embodiments, the sensor assembly 152 may be disposed in the second cover outer hole 260 of the second meter cover 110, as best shown in FIG. 2B. A junction box 114 may be connected to and configured to provide power and signal connections to the sensor assembly 152. When the sensor assembly 152 is disposed in the second cover outer hole 260, a sensor housing face 902 as part of the sensor assembly 152 may be positioned proximate to the reluctor ring 252.

FIG. 9B shows the components of a sensor assembly 152 according to one or more embodiments. The sensor assembly 152 includes a sensor 904 having sensor face 906 and a sensor housing 908 having a sensor housing face 902. The sensor face 906 end of the sensor 904 may be disposed in the sensor housing 908 proximate the sensor housing face 902 such that the sensor face 906 is also in close proximity to the reluctor ring 252. The sensor housing 908 provides protection for the sensor 904 from fluid and pressure present within the positive displacement meter 100. The sensor housing 908 according to one or more embodiments is a precision machined part which accurately positions the sensor 904 into the second meter cover 110. The sensor housing 908 also serves as a static pressure barrier from pressurized fluid inside the positive displacement meter 100 to the outside environment. As shown in FIG. 9B, an end of the sensor housing 908 opposite the sensor housing face 902 is disposed into the union 116, which in turn connects the sensor assembly 152 to the junction box 114.

FIG. 9C shows sensor path 924 of the sensor assembly 152 according to one or more embodiments. In FIG. 9C, the junction box 114 is shown connected to the sensor assembly 152 via a union 116. The sensor assembly 152 is positioned within the second cover outer hole 260 on the second cover outer surface 732 such that a sensor housing outer protrusion 926 is located proximate to the second cover outer surface 732 and the sensor housing face 902 is located within the meter housing 102 proximate the reluctor ring 252. Sensor 904 (not shown in FIG. 9C) is disposed within the sensor housing 908 such that the sensor face 906 is located proximate the sensor housing face 902. In one or more embodiments, the reluctor ring 252 includes a plurality of reluctor ring slots 922, radially disposed around the reluctor ring 252. The sensor 904 is configured to detect the plurality of reluctor ring slots 922 via sensor path 924, as the rotor assembly 204 rotates within the meter housing 102.

FIG. 9D shows a zoomed in portion of a sensor assembly according to one or more embodiments. As best shown in FIG. 9D, the sensor housing face 902 as part of sensor assembly 152 may be positioned proximate the reluctor ring 252 of the rotor assembly 204, within the second meter cover 110.

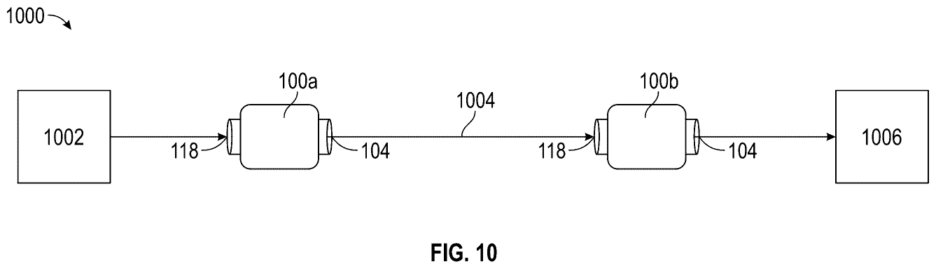

Embodiments disclosed herein also relate to a system including one or more positive displacement meters 100, as shown in FIG. 10. In the system 1000, a pipeline 1004 may be fluidly connected to an upstream process 1006 and a downstream process 1002. Fluid flow along the pipeline 1004 is in a direction indicated by the arrows shown in FIG. 10. The pipeline 1004 according to one or more embodiments may refer to an oil and gas pipeline, however, the positive displacement meters 100 disclosed herein may be used in any application requiring measuring a volume of flowing fluid.

The system 1000 of one or more embodiments includes at least one positive displacement meter 100 disposed on the pipeline. For example, as shown in FIG. 10, a first positive displacement meter 100a and a second positive displacement meter 100b are shown positioned on the pipeline 1004. While the system 1000 of FIG. 10 depicts two positive displacement meters 100, the described system 1000 is intended merely for illustration and is not intended to be limiting; any number of positive displacement meters 100 may be used in the system 1000.

The first positive displacement meter 100a and the second positive displacement meter 100b may include any of the features described in the above figures, including a fluid inlet 118 and a fluid outlet 104. Fluid inlets 118 on the first positive displacement meter 100a and on the second positive displacement meter 100b may be fluidly connected to a downstream side of the pipeline 1004. As a fluid flows from a downstream process 1002 and through the pipeline 1004, the fluid may enter a flow bore formed within a meter inner measurement chamber 208 (not shown in FIG. 10) of the first positive displacement meter 100a and within the second positive displacement meter 100b via fluid inlets 118. Upon flowing through the flow bore, the fluid may flow through fluid outlets 104, located on an opposite end of the flow bore from fluid inlets 118. Finally, in the system 1000, the first positive displacement meter 100a and the second positive displacement meter 100b are configured to measure a volume of fluid flowing through the pipeline 1004 from the downstream process 1002 to the upstream process 1006.

Embodiments disclosed herein also relate to methods for measuring a volume of fluid, as described generally in reference to FIGS. 4 and 10. In one or more embodiments, methods for measuring a volume of fluid include disposing at least one positive displacement meter 100 on a pipeline 1004. Each of the at least one positive displacement meters 100 includes a meter housing 102, a meter inner measurement chamber 208 defining a flow bore through which a fluid is directed (e.g., flow path 402), a fluid inlet 118 located on an end of the flow bore, and a fluid outlet 104 located on an opposite end of the flow bore from the fluid inlet 118.

The at least one positive displacement meter 100 may also include a rotor assembly 204 rotatably supported within the meter inner measurement chamber 208. The rotor assembly 204 may include a plurality of rotor blades 406 and a crankshaft 408 disposed within a central opening (e.g., 602 in FIG. 6C) of each of the plurality of rotor blades 406. In one or more embodiments, the crankshaft 408 is constructed as a single body. In some embodiments, the crankshaft 408 may be constructed from a combination of parts to form a crankshaft 408 assembly. The at least one positive displacement meters 100 may also include a first meter cover (e.g., 106) and a second meter cover (e.g., 110), where the first meter cover 106 and the second meter cover 110 are bolted to opposites sides of the meter housing 102 to cover the meter inner measurement chamber 208, thereby containing the fluid in the meter inner measurement chamber 208. The at least one positive displacement meter 100 may also include any of the elements described in the preceding figures.

The method of one or more embodiments further includes flowing the fluid through the pipeline 1004, through the fluid inlet 118 of the at least one positive displacement meter 100. In some embodiments, flowing the fluid through the pipeline 1004 includes flowing the fluid from a downstream process 1002 fluidly connected to the pipeline 1004. In one or more embodiments, upon entering the meter inner measurement chamber 208 via fluid inlet 118, the flowing fluid rotates the plurality of rotor blades 406 around the crankshaft 408 within the rotor assembly 204. As described in FIGS. 6A-B above, a reluctor ring 252 may be affixed to a rotor second side 603 of the rotor body 404. As the flowing fluid rotates the plurality of rotor blades, the reluctor ring 252 also rotates.

In one or more embodiments, as described in FIGS. 9A-9C, the one or more positive displacement meter 100 may further include a sensor assembly 152. The sensor assembly may include a sensor housing 908 having a sensor housing face 902 and a sensor 904 having a sensor face 906. The sensor face 906 may be disposed within the sensor housing 908, proximate the sensor housing face 902, and the sensor housing face 902 may be disposed within the meter inner measurement chamber 208, proximate to the reluctor ring 252. A plurality of reluctor ring slots 922 may be formed radially around the reluctor ring 252. In one or more embodiments, the method further includes detecting, with the sensor 904, the plurality of reluctor ring slots 922 as the rotor assembly 204 rotates in response to the flowing fluid.

The method of one or more embodiments further includes flowing the fluid (e.g., via flow path 402) to fluid outlet 104 and measuring the volume of the fluid as it flows through the at least one positive displacement meter 100. In one or more embodiments, measuring the volume of fluid further includes correlating a number of the plurality of reluctor ring slots 922 detected by the sensor 904 to the volume of fluid flowing through the at least one positive displacement meter 100. In some embodiments, flowing the fluid through the pipeline 1004 includes, upon directing the fluid through the fluid outlet 104 of the at least one positive displacement meter 100, flowing the fluid to an upstream process 1006 fluidly connected to the pipeline 1004.

Embodiments disclosed herein may provide at least one of the following advantages.

Positive displacement meters according to one or more embodiments may be manufactured with a controlled dimensional tolerance in the range of ten-thousandths of an inch.

The positive displacement meter described herein is not dependent on fluid pressure or viscosity to move a mechanical element to create a capillary seal. In contrast, a capillary seal is created by operational conditions that meet the application specifications for the meter (e.g., flow rates and fluid type).

The block element design according to one or more embodiments has a longer arc length (e.g., longer area) to provide a capillary seal as compared to prior art. Therefore, the block element disclosed herein provides less drag potential at low flow rates compared to prior art. Additionally, the machined in block element reduces stack-up of tolerances due to multiple parts, thus better controlling capillary seal clearances compared to prior art.

The crankshaft design according to one or more embodiments may provide reduced force on the blade slot and crankshaft journal due to reduced acceleration forces as compared to prior art. The crankshaft design may also advantageously provide reduced wear of the rotating components, resulting in longer service life. Furthermore, the crankshaft design according to one or more embodiments may provide reduced drag at lower flow rates allowing for better meter turndown and reduced drag at higher flow rates allowing for increased high flow rates. The crankshaft design may also provide improved repeatability performance within the positive displacement meter due to less drag on the rotor blades.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A positive displacement meter, comprising:
a meter housing, comprising:
a meter inner measurement chamber defining a flow bore through which a fluid is directed,
a fluid inlet located on an end of the flow bore, and
a fluid outlet located on an opposite end of the flow bore from the fluid inlet, wherein the fluid flows from the fluid inlet, through the meter inner measurement chamber, and to the fluid outlet;
a rotor assembly rotatably supported within the meter inner measurement chamber, wherein the rotor assembly is configured to rotate as the fluid flows through the meter inner measurement chamber;
wherein the rotor assembly comprises:
a plurality of rotor blades, each of which includes two interconnected, diametrically opposite blades, and
a crankshaft disposed within a central opening of each of the plurality of rotor blades, wherein the crankshaft is constructed as a single body or as an assembly of parts;
a first meter cover; and
a second meter cover,
wherein the first meter cover and the second meter cover are bolted to opposites sides of the meter housing to cover the meter inner measurement chamber, thereby containing the fluid in the meter inner measurement chamber.

2. The positive displacement meter of claim 1, wherein:
the first meter cover comprises;
a first cover inner surface having a first cover inner hole, and
a first cover outer surface having a first cover outer hole, wherein:
the first cover inner surface axially aligns with and faces the meter inner measurement chamber, and
the first cover outer surface is located axially opposite the first cover inner surface; and
the second meter cover comprises;
a second cover inner surface having a second cover inner hole, and
a second cover outer surface having a second cover outer hole, wherein:
the second cover inner surface axially aligns with and faces the meter inner measurement chamber, and
the second cover outer surface is located axially opposite the second cover inner surface.

3. The positive displacement meter of claim 1, wherein the plurality of rotor blades are constructed from injection molded plastics, cast metal, or as an assembly or parts.

4. The positive displacement meter of claim 1, wherein the rotor assembly further comprises:
a rotor body, radially surrounding the rotor assembly, wherein the rotor body comprises a rotor first side and a rotor second side, the rotor first side located axially opposite the rotor second side;
a rotor cover affixed to the rotor first side of the rotor body;
a reluctor ring affixed to the rotor second side of the rotor body.

5. The positive displacement meter of claim 4, wherein the rotor body and the rotor cover further comprise a plurality of slots configured to fit the plurality of rotor blades.

6. The positive displacement meter of claim 2, wherein:
the rotor assembly is affixed to the positive displacement meter by;
inserting a crankshaft first end nub, located on a crankshaft first end surface, into the first cover inner hole,
inserting a crankshaft bolt through the first cover outer hole, the first cover inner hole, and into a crankshaft first end hole, and
inserting a crankshaft second end surface into the second cover inner hole,
wherein the crankshaft first end surface is located axially opposite the crankshaft second end surface.

7. The positive displacement meter of claim 4, further comprising:
a sensor assembly, comprising;
a sensor housing having a sensor housing face; and
a sensor having a sensor face, wherein:
the sensor face is disposed within the sensor housing, proximate the sensor housing face,
the sensor housing face is disposed within the meter inner measurement chamber, proximate to the reluctor ring, and
the sensor is configured to detect a plurality of reluctor ring slots, radially disposed around the reluctor ring, as the rotor assembly rotates.

8. The positive displacement meter of claim 2, wherein:
a sensor assembly is affixed to the positive displacement meter by;
inserting the sensor assembly into the second cover outer hole, through a wall of the second meter cover,
affixing a union and a junction box to an end of the sensor housing located axially opposite to the sensor housing face of the sensor assembly, wherein the junction box is configured to provide field connections for power and signal to the sensor assembly.

9. The positive displacement meter of claim 1, further comprising a block element machined within an inner wall of the meter inner measurement chamber.

10. The positive displacement meter of claim 9, wherein the block element is configured to provide a capillary seal when a block outer surface of the block element comes in close proximity to an outer surface of the rotor assembly.

11. A system, comprising:
a pipeline fluidly connected to an upstream process and a downstream process;
at least one positive displacement meter disposed on the pipeline, each of the at least one positive displacement meters comprising:
a meter housing, comprising:
a meter inner measurement chamber defining a flow bore through which a fluid is directed,
a fluid inlet located on an end of the flow bore, and
a fluid outlet located on an opposite end of the flow bore from the fluid inlet, wherein the fluid flows from the fluid inlet, through the meter inner measurement chamber, and to the fluid outlet;
a rotor assembly rotatably supported within the meter inner measurement chamber,
wherein the rotor assembly is configured to rotate as the fluid flows through the meter inner measurement chamber;
wherein the rotor assembly comprises:
a plurality of rotor blades, each of which includes two interconnected, diametrically opposite blades, and
a crankshaft disposed within a central opening of each of the plurality of
rotor blades, wherein the crankshaft is constructed as a single body or as an assembly of parts;
a first meter cover; and
a second meter cover,
wherein the first meter cover and the second meter cover are bolted to opposites sides of the meter housing to cover the meter inner measurement chamber, thereby containing the fluid in the meter inner measurement chamber,
wherein the at least one positive displacement meter is configured to measure a volume of fluid flowing through the pipeline from the downstream process to the upstream process.

12. The system of claim 11, wherein the rotor assembly further comprises:
a rotor body, radially surrounding the rotor assembly, wherein the rotor body comprises a rotor first side and a rotor second side, the rotor first side located axially opposite the rotor second side;
a rotor cover affixed to the rotor first side of the rotor body;
a reluctor ring affixed to the rotor second side of the rotor body.

13. The system of claim 12, wherein the at least one positive displacement meter further comprises:
a sensor assembly, comprising;
a sensor housing having a sensor housing face; and
a sensor having a sensor face, wherein:
the sensor face is disposed within the sensor housing, proximate the sensor housing face,
the sensor housing face is disposed within the meter inner measurement chamber, proximate to the reluctor ring, and
the sensor is configured to detect a plurality of reluctor ring slots, radially disposed
around the reluctor ring, as the rotor assembly rotates.

14. The system of claim 11, wherein the at least one positive displacement meter of further comprises a block element machined within an inner wall of the meter inner measurement chamber.

15. The system of claim 14, wherein the block element is configured to provide a capillary seal when a block outer surface of the block element comes in close proximity to an outer surface of the rotor assembly.

16. A method for measuring a volume of fluid, comprising:
disposing at least one positive displacement meter on a pipeline, each of the at least one positive displacement meters comprising:
a meter housing, comprising:
a meter inner measurement chamber defining a flow bore through which the fluid is directed,
a fluid inlet located on an end of the flow bore, and
a fluid outlet located on an opposite end of the flow bore from the fluid inlet, wherein the fluid flows from the fluid inlet, through the meter inner measurement chamber, and to the fluid outlet;
a rotor assembly rotatably supported within the meter inner measurement chamber,
wherein the rotor assembly comprises:
a plurality of rotor blades, each of which includes two interconnected, diametrically opposite blades, and
a crankshaft disposed within a central opening of each of the plurality of rotor blades, wherein the crankshaft is constructed as a single body or as an assembly of parts;
a first meter cover; and
a second meter cover,
wherein the first meter cover and the second meter cover are bolted to opposites sides of the meter housing to cover the meter inner measurement chamber, thereby containing the fluid in the meter inner measurement chamber;
flowing the fluid through the pipeline, through the fluid inlet of the at least one positive displacement meter;
rotating the rotor assembly within the meter inner measurement chamber, as the fluid flows through the meter inner measurement chamber;
flowing the fluid to the fluid outlet of the at least one positive displacement meter; and
measuring the volume of the fluid as it flows through the at least one positive displacement meter.

17. The method of claim 16, wherein flowing the fluid through the pipeline further comprising flowing the fluid from an upstream process fluidly connected to the pipeline to a downstream process fluidly connected to the pipeline.

18. The method of claim 16, wherein the rotor assembly further comprises:
a rotor body, radially surrounding the rotor assembly, wherein the rotor body comprises a
rotor first side and a rotor second side, the rotor first side located axially opposite the rotor second side;
a rotor cover affixed to the rotor first side of the rotor body;
a reluctor ring affixed to the rotor second side of the rotor body.

19. The method of claim 18, wherein the at least one positive displacement meter further comprises:
a sensor assembly, comprising:
a sensor housing having a sensor housing face; and
a sensor having a sensor face, wherein:
the sensor face is disposed within the sensor housing, proximate the sensor housing face,
the sensor housing face is disposed within the meter inner measurement chamber, proximate to the reluctor ring, and
the sensor is configured to detect a plurality of reluctor ring slots, radially disposed around the reluctor ring, as the rotor assembly rotates, and
the method further comprises detecting a plurality of reluctor ring slots, radially disposed around the reluctor ring, as the rotor assembly rotates.

20. The method of claim 19, wherein flowing the fluid rotates the plurality of rotor blades and the reluctor ring and measuring the volume of the fluid further comprises correlating a number of the plurality of reluctor ring slots detected by the sensor to the volume of fluid flowing through the at least one positive displacement meter.
